(19) United States
(12) Patent Application Publication
(10) Pub. No.: US 2010/0158240 A1
(43) Pub. Date: Jun. 24, 2010

(54) TELECOMMUNICATION TERMINAL WITH LIGHT BEAM SCANNER

(75) Inventor: Karthik Chandrashekar Iyer, Bangalore (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/600,570

(22) PCT Filed: May 27, 2008
(86) PCT No.: PCT/IB08/52073

§ 371 Date: Nov. 17, 2009

(30) Foreign Application Priority Data
Jun. 4, 2007 (EP) 07109551.7

(51) Int. Cl. H04M 1/22

(52) U.S. Cl. 379/396

(57) ABSTRACT

A telecommunication terminal contains a two direction light beam scanner (140, 142, 144) for emitting a deflected light beam from the telecommunication terminal. A control circuit (16) activates the light beam scanner (140, 142, 144) to successively deflect the light beam in directions according to a two-dimensional direction pattern of deflections defining an image dependent on programmable control information, in response to detection 5 of a telecommunication signal by the reception circuit (12). In an embodiment at least part of the direction pattern is selected dependent on a content of a ring-tone signal.

### FIELD OF THE INVENTION

The invention relates to a telecommunication terminal such as mobile telephone.

### BACKGROUND OF THE INVENTION

Various methods are known to indicate “ringing”, i.e. the fact that a signal has been received by a telecommunications terminal. These methods include use of a sound signal (such as the old bell signal that has given rise to the generalized term ringing), a mechanical vibration signal or an optical signal and combinations thereof.

U.S. patent application No. 20060077384 discloses a mobile telephone with an illumination structure that may be used for ringing. The illumination structure comprises a plurality of different color LEDs (Light Emitting Diodes) and a diamond shaped lens. Unlike a conventional lens, which forms a single (virtual) image of each LED in an (virtual) image plane, the diamond shaped lens has the effect that a plurality of (virtual) images of each LED is formed. An embodiment is described wherein the LEDs and the lens can be displaced relative to each other, so that the locations of the images can be changed. The emitted light can be observed directly by directing the mobile telephone at a wall or any other screen, or by directly capturing light from the diamond shaped lens with the human eye. This illumination structure can be used to indicate ringing.

Compared to visual indication of ringing on the display screen of the mobile telephone, they technique has the advantage that a brighter image can be perceived. The location of the image is not limited to locations on the mobile telephone. Thus, it may be easier to observe a ringing signal at a distance from the mobile telephone. Dependent on the identity of the caller, different combinations of colors or relative orientations of the LEDs and the lens may be used to create different light patterns. However, the different patterns that can be realized are limited by the shape of the lens and the available range of displacement, if any, of the lens relative to the LEDs.

### SUMMARY OF THE INVENTION

Among others, it is an object to provide for a telecommunications terminal that is able to give an optical indication of ringing wherein a bright image is defined that need not be present on the surface of the telecommunications device and wherein a greater degree of control over the image is possible.

A telecommunication terminal according to claim 1 is provided. Herein a two-direction light beam scanner is used to emit a deflected light beam from the telecommunication terminal, for example to form a wire frame image on a surface at a distance from the telecommunication terminal. Emission of a two-dimensional direction pattern of successive deflections of the light beam, which defines an image, is triggered by reception of a telecommunication signal. The pattern is programmable. Thus, for example, ringing can be indicated by generating a moving light beam from the telecommunication terminal.

Also a telecommunication terminal is provided wherein parameter of a ring tone signal that defines a sound pattern of a ringtone is used to control at least a part of an image. Thus, for example, a part of a generated image can be made to move relative to another part of the generated image in the rhythm of the ring tone.

### BRIEF DESCRIPTION OF THE DRAWINGS

These and other objects and advantageous aspects will become apparent from the description of exemplary embodiments, using the following Figures.

FIG. 1 shows a telecommunications terminal

FIG. 2 shows a control circuit

### DETAILED DESCRIPTION OF EXEMPLARY EMBODIMENTS

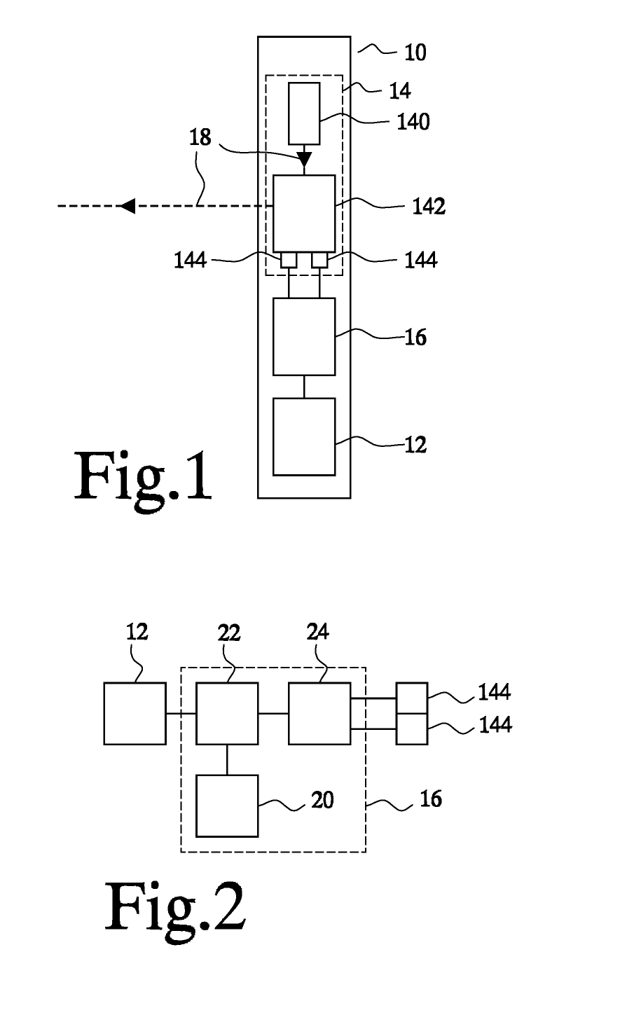

FIG. 1 shows a telecommunication terminal body 10, containing a reception circuit 12, an optical indicator system 14 and a control circuit 16. Control circuit 16 has an input coupled to reception circuit 12 and an output coupled to a control input of optical indicator system 14. In operation, the optical indicator system 14 emits a beam 18 of light in selectable directions.

Optical indicator system 14 comprises a light beam scanner comprising a light beam source 140, a drivable mirror assembly 142 and motors 144 driving the mirrors of mirror assembly 142. Optical indicator system 14 operates as a beam scanner, which varies the direction of the beam 18 as a function of time, so that a wire frame image can be formed when the beam is projected on a surface at a distance from the telecommunication terminal, by scanning the beam to trace the lines of the wire frame. For this it is required that the beam emitted by the light beam scanner effectively does not diverge, in the sense that at distance in normal human environments where the telecommunication terminal will be used, such as in a room of a house or in an office a scanning spot will result from projection.

This is realized by using light beam source 140 as part of the scanner. As used herein a light beam source is a light source such as a laser or a point source combined with appropriate lenses, that is configured to output a beam that effectively does not diverge. As used herein a beam that effectively does not diverge may be any beam that forms a small spot, of less than 10 mm diameter when projected at a surface at a distance of one meter. As used herein, a light beam scanner is a device that emits a light beam that effectively does not diverge and varies the direction of emission of the light beam. A two-dimension light beam scanner is a light beam scanner wherein the direction of emission of the light beam can be changed in two mutually transverse scanning directions perpendicular to the emission direction.

Beam scanners are known per se. Therefore optical indicator system 14 will not be described in detail. In an embodiment light beam source 140 is a laser source, comprising for example a laser diode, that generates beam 18. Beam 18 is deflected into a direction determined by rotating the mirrors of mirror assembly 142 with motors 144. Instead of one or more of the mirrors refractive elements (e.g. rotating prisms) may be used in mirror assembly 142. The term driveable light deflection assembly will be used to indicate mirror assembly 142 and types of assembly that use refraction to deflect the beam. Motors 144 may be electromotors or any other type of mechanical drivers. Preferably they may be arranged to rotate mirrors in mirror assembly 142, but alternatively motors 144 may be used to displace mirrors, or to provide for a combination of rotation and displacement of the mirrors.

FIG. 2 shows an embodiment of control circuit 16. In this embodiment control circuit 16 comprises a ring tone memory 20, a processor 22 and a pattern generator 24. Processor 22 has a trigger input coupled to an output of reception circuit 12 and read interface coupled to ring tone memory 20. Processor 22 has an output coupled to an input of pattern generator 24. Pattern generator 24 has an output coupled to control inputs of motors 144.

In operation reception circuit 12 detects incoming calls and signals each incoming call to processor 22, when it is detected. In response, processor 22 sends a trigger signal to pattern generator 24. Upon receiving the trigger signal pattern generator 24 repetitively generates a pattern of control signals for motors 144.

In an embodiment the pattern comprises a fixed part and a variable part. These parts of the pattern may be configured to define respective subsets of the lines of a wire frame image. In this embodiment pattern generator 24 comprises a pattern memory storing information that defines the fixed part and the variable part. In response to the trigger signal indicating the incoming call, processor 22 reads a ring tone signal from ring tone memory 20. As used herein, a ring tone signal is any signal that may be used to control audible output of the telecommunication terminal in response to an incoming call signal. Optionally processor 22 decodes the ring tone signal and uses the decoded signal to control an audio output signal from an audio output device (not shown) of the telecommunication terminal. Processor 22 processes the ring tone signal to extract ring tone signal dependent parameters as a function of time and sends the ring tone signal dependent parameters to pattern generator 24. Pattern generator 24 uses the ring tone signal dependent parameters to control selection of the variable part.

In a further embodiment, a variable part with fixed shape is used and the ring tone signal dependent parameters control the relative position of the variable part relative to the fixed part of the pattern. Thus, pattern generator 24 outputs cycles of control signals for motors 144, each cycle comprising control signals according to the fixed part of the pattern and signals according to the variable part of the pattern. Preferably, the cycles have a temporal duration that allows the pattern in the cycle to be observed as an image, e.g. a duration of less than forty milliseconds. The fixed part may define a sequence of steps with rotations that have to be applied by motors 144. The fixed part causes the mirrors of mirror assembly 142 to deflect beam 18 in a fixed series of directions relative to body 10. The variable part causes the mirrors of mirror assembly 142 to deflect beam 18 in a series of directions relative to body 10 according to a predetermined sub-pattern, with all directions of the sub-pattern shifted over an angle that depends on the cycle and that is controlled by the ring tone signal dependent parameter at a time point defined in the ringtone signal that has a predetermined time relation to the time of performing the cycle with mirror assembly 142. For example, if the ringtone signal is audibly reproduced by the terminal the parameter of the ringtone signal at the time of display may be used to control the variable part, or the parameter a predetermined time interval earlier or later may be used. Even if the ringtone signal is audibly reproduced, the parameter values at notional time points at which it would be reproduced if started triggered by an incoming call may be used to control the variable part.

Alternatively, the ring tone signal dependent parameters may be used to control size of the variable part relative to the fixed part of the pattern. This may be realized by amplifying or attenuating the mirror movements dependent on the ring tone signal dependent parameters. As another alternative the ring tone signal dependent parameters may be used as an index to select a sub-pattern form a set of predefined patterns, representing successive images in a video sequence. Other aspects of the variable pattern may be controlled as well, such as regional spatial deformation (warping) and combinations of displacement resizing, selection from a set and/or deformation.

Processor 22 may determine the ring tone signal dependent parameters in various ways. In one example the ring tone signal dependent parameters comprise the sound amplitude of the ring tone as a function of time. Such parameters may be determined by averaging the absolute value of sample values of the sound during a sliding time window at different temporal positions. However, other parameters may be used, such as sound amplitudes in various frequency bands, indices of the frequency band than contain the highest amplitude at respective times, duration between successive temporal maxima of the amplitude (i.e. rhythm) etc. Such ring tone signal dependent parameters may be derived from a frequency band encoded audio signal, such as an MP3 signal, without fully decoding the audio signal into sample values, for example from scale factors for different frequency bands, or averages thereof over time and/or over sets of frequency bands.

In an example the fixed part of the pattern may be used to represent a background and the variable part may be used to represent a ball. In this example, ring tone amplitude may be used to control a height at which the ball is displayed against the background. In another example the variable part may be selected from a series of scanner motion patterns, each representing a successive pose of a dancing Figure. In this embodiment ring tone amplitude may be used to control progress through the series of poses.

Although a specific embodiment has been described, it should be appreciated that alternative implementations are possible. For example, control dependent on an audio ringtone signal has been used to make it unnecessary to define predetermined changes of the scanned pattern, or to provide memory for such a definition. However, alternatively information defining predetermined successive cycles of scanning motion may be loaded into pattern generator 24. Permanently loaded information may be used, or the telecommunication terminal may be provided with an interface to download such information, e.g. in the same way in which ringbones can be downloaded. In this case processor 22 only needs to trigger pattern generator 24 to output a predetermined time series of cycles of control signals: no parameter determination is needed to control a variable pattern.

Furthermore, although it is preferred to use a laser light beam source in optical indicator system 14, it should be appreciated that alternatively other types of light beam source, such as a LED combined with beam forming optics, may be used to form the beam. An advantage of a laser light beam source is its brightness. Application of such a source to an optical indicator system 14 in a communication terminal has the advantage that ringing can be observed visually from a larger distance.

In an embodiment, the intensity of the light beam source may be modulated as a function of time during scanning In a further embodiment the modulation pattern may be selected dependent on rind tone dependent parameters.

Instead of a light beam scanner a display could be used to display an image that is partly defined under control of a parameter derived from the ringtone signal, e.g. by moving a part of the image with a displacement controlled by the parameter, preferably as a function of time, or by rotating, resizing or deforming the part by an amount controlled by the parameter, or selecting the part from a series of images under control of the parameter. However, use of beam scanning to generate the images has the advantage that the images can be made larger than the terminal and that ringing can be observed at a greater distance.

The telecommunication terminal is preferably a mobile telephone. But it should be appreciated that an optical indicator system 14 as described may be used also in other types of terminal, such as wired telephones, pagers etc, that have to indicate ringing signals (i.e. signals to attract the attention of a human user when the terminal was previously standby). In addition the optical indicator system 14 may be used to indicate signals other than ringing. Although processor 22 and pattern generator 24 are shown separately, it should be appreciated that the function of both may be performed by a single processor. Also the pattern generator may provide the pattern to the processor for modification dependent on the parameters by the processor, instead of by the pattern generator.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A telecommunication terminal, comprising a reception circuit, a control circuit and a light beam scanner for emitting a deflected light beam from the telecommunication terminal with a beam emission direction that is controllable two mutually transverse directions, the control circuit being coupled between the reception circuit and the light beam scanner, the control circuit being configured to activate the light beam scanner to successively change the emission direction of the light beam along scanning directions according to a two-dimensional direction pattern of emission direction changes, defining an image dependent on programmable control information, in response to detection of a telecommunication signal by the reception circuit.

2. A telecommunication terminal according to claim 1, comprising a ring tone memory for storing a ringtone signal defining a sound pattern of a ringtone, the control circuit comprising a processor coupled to the ringtone memory for receiving the ringtone signal, the processor being configured to determine a parameter of the ringtone signal and to control at least a part of the direction pattern dependent on the parameter.

3. A telecommunication terminal according to claim 2, wherein the direction pattern comprises successive cycles, each defining a successive image, the control circuit being configured to control a variation of said part between different cycles dependent on the parameter as a function of time.

4. A telecommunication terminal according to claim 2, wherein the direction pattern comprises a predetermined part, the control circuit being configured to control the predetermined part of the direction pattern independent of the ringtone signal.

5. A telecommunication terminal according to claim 2, wherein the control circuit is configured to control an amount of offset angle of a predetermined sub-pattern of deflections of the beam dependent on said parameter.

6. A telecommunication terminal according to claim 2, wherein the control circuit is configured to select said part from a plurality of patterns dependent on said parameter.

7. A telecommunication terminal according to claim 1, wherein the light beam scanner comprises a laser beam source for forming the beam.

8. A telecommunication terminal, comprising:
a ring tone memory for storing a ringtone signal defining a sound pattern of a ringtone,
a control circuit, the control circuit being coupled to the ringtone memory for receiving the ringtone signal and to determine a parameter of the ringtone signal,
a reception circuit, and
an image generation device, the control circuit further being coupled between the reception circuit and the image generation device, the control circuit being configured to activate the image generation device to generate an image, the control circuit controlling a content of the image that at least partly dependent on said parameter.

9. A method of operating a communication terminal, the method comprising:
receiving a ringtone signal that defines a sound pattern of a ringtone;
determining a parameter of the ringtone signal,
activating an image generation device to generate an image visible outside the communication terminal;
controlling a content of the image at least partly dependent on said parameter.

10. A method according to claim 9, comprising performing said activating automatically in response to receiving a call signal.

11. A computer program product, comprising instructions that, when executed by a programmable processor cause the processor to perform the method of claim 9.
